(19) United States
(12) Patent Application Publication
(10) Pub. No.: US 2012/0019522 A1
(43) Pub. Date: Jan. 26, 2012

(54) ENHANCED SITUATIONAL AWARENESS AND TARGETING (eSAT) SYSTEM

(75) Inventors: Robert J. Lawrence, Oro Valley, AZ (US); Eric S. Prostejovsky, Tucson, AZ (US); William B. O'Neal, Tucson, AZ (US); Jeff S. Wolske, Tucson, AZ (US)

(73) Assignee: Raytheon Company

(21) Appl. No.: 13/183,155

(22) Filed: Jul. 14, 2011

Related U.S. Application Data
(60) Provisional application No. 61/367,438, filed on Jul. 25, 2010.

(51) Int. Cl. G06T 15/00

(52) U.S. Cl. 345/419

(57) ABSTRACT

eSAT pushes 3D scene awareness and targeting to forward positioned mobile operators and their handheld devices in environments such as found in military theaters of operation, border control and enforcement, police operations, search & rescue and large commercial industrial operations. A host computer hosts a 3D model of a scene and dynamically captures and transmits a windowed portion of the visual representation of that 3D model over a wireless network to the mobile operators' handheld devices. The windowed portion of the visual representation is streamed directly to the operators' handheld device displays. The mobile operators may interact with and control the 3D model via the wireless network. The host computer may synthesize the visual representation of the 3D model with live feeds from one or more of the handheld devices or other assets to improve situational awareness. Either the mobile operators or host operator can make point selections on the visual representation to extract geo-coordinates from the 3D model as a set of target coordinates.

### CROSS-REFERENCE TO RELATED APPLICATIONS

This application claims benefit of priority under 35 U.S.C. 119(e) to U.S. Provisional Application No. 61/367,438 entitled “ENHANCED SITUATIONAL AWARENESS AND TARGETING (eSAT) SYSTEM” and filed on Jul. 25, 2010, the entire contents of which are incorporated by reference.

### BACKGROUND OF THE INVENTION

1. Field of the Invention

This invention relates to systems and methods for providing enhanced situational awareness and targeting capabilities to forward positioned mobile operators in environments such as found in military theaters of operation, border control and enforcement, police operations, search & rescue and large commercial industrial operations.

2. Description of the Related Art

With today's technology, three-dimensional (3D) characteristics of scenes are revealed in several ways. 3D characteristics may be cognitively portrayed by presenting different visual perspectives to a person's right and left eyes (i.e. red/green glasses or alternating polarized lenses on right/left eye). Another approach is to alter the viewpoints of an observed scene dynamically over time. This allows the scene to be displayed as a two dimensional (2D) image, but the 3D nature of the scene is revealed by dynamically changing the viewpoints of the 3D rendered scene.

Computer technology can be used to create and present a visual representation of a 3D model from different viewpoints. Often, these 3D models are called “point clouds”, with the relative locations of points in 3D representing the 3D nature of the scene. LIDAR and LADAR are two examples of this technology. However, these technologies offer 3D point clouds from a limited viewpoint. For example, overhead aircraft assets equipped with LIDAR or LADAR cameras only collect 3D information from a nadir viewpoint. This exposes a limitation when trying to view a 3D scene from a viewpoint other than that which was observed by the LIDAR/LADAR collection platform. Furthermore, LADAR is limited in its ability to represent surface texture and scene color in the 3D rendering or representation. Digital photogrammetric techniques such as GeoSynth™ address the viewpoint limitations by creating the 3D model from 2D images such as ordinary photographs or, for example, IR band sensors. These techniques reveal their 3D nature by manipulating the 3D point cloud model on the computer's display to present a visual representation from different viewpoints around, or in, the scene.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention provides an eSAT system of enhanced situational awareness and targeting capabilities that push 3D scene awareness and targeting to forward positioned mobile operators and their handheld devices in environments such as found in military theaters of operation, border control and enforcement, police operations, search & rescue and large commercial industrial operations.

In an embodiment, a host computer is provided with a three-dimensional (3D) model rendered from images of a scene. The host computer displays a visual representation of the 3D model from a specified viewpoint. The host computer is configured to allow host operator manipulation of the 3D model to change the viewpoint. A window (or windows) is placed on the display about a portion of the visual representation of the 3D model. The window(s) may be placed by the host operator or by the host computer in response to a command from a mobile operator, the operator's handheld device or another asset. The host computer dynamically captures a windowed portion of the visual representation at a given refresh rate and streams the windowed portion over a wireless network to the handheld devices of one or more mobile operators forward positioned in the vicinity of the scene. The handheld devices are configured to allow mobile operator selection of the window to stream the windowed portion of the visual representation to a handheld device display.

In an embodiment, the images are recorded by a forward positioned UAV that flies above the scene and provides the images directly to the host computer to render the 3D model. The mobile operators' handheld devices may capture still or moving images and transmit the images over the wireless network to the host computer to update the 3D model in time, spatial extent or resolution. The images may be captured as, for example, 2D or 3D images of the scene.

In an embodiment, the 3D model is suitably geo-registered in scale, translation and rotation to display the visual representation from geo-accurate viewpoints. Geo-registration may be achieved using laser position sensing from various aerial or terrestrial platforms.

In an embodiment, the host computer synthesizes the visual representation of the 3D model with live feeds of images from one or more of the mobile operators' handheld devices. The host computer may slave the viewpoint of the 3D model to that of one of the live feeds and may embed that live feed within the visual representation of the 3D model. The host computer (or mobile operator via the host computer) may slave the viewpoint of a UAV to a selected viewpoint of the 3D model. The host computer may obtain the geo-coordinates of at least the handheld devices transmitting the live feeds and display a geo-located marker for each of the geo-located operators within the visual representation of the 3D model. The host operator may select a single point on the visual representation of the 3D model to extract geo-coordinates from the 3D model. These geo-coordinates may be used to deploy an asset to the coordinates.

In an embodiment, the mobile operators interact with the 3D model via the wireless network and host computer. A mobile operator may generate a 3D model manipulation command from the operator's handheld device and transmit the command over the wireless network to the host computer, which in turn executes the command on the 3D model to update the visual representation of the 3D model. The updated visual representation is streamed back to at least the requesting mobile operator. The model manipulation command may be the current viewpoint of the handheld device whereby the visual representation of the 3D model is slaved to that viewpoint. If multiple operators issue overlapping commands, the host computer may execute them in sequence or may open multiple windows executing the commands in parallel. If the window captures the icon of a host computer application, the mobile operator may select the icon and generate an application command that is transmitted over the wireless network to the host computer allowing the mobile operator to operate the application. The mobile operator may select a point on the handheld display to generate a target point selection command that is transmitted to the host computer, which in turn extracts the geo-coordinates from the 3D model.

In an embodiment, either the forward positioned host computer or the mobile operator's handheld device captures a live feed of the scene in a global positioning satellite (GPS) signal-denied environment and correlates the live feed to the 3D model to estimate geo-coordinates of the host computer or handheld device. The visual representation of the 3D model may be slaved to the current viewpoint of the host computer or handheld device and displayed with the live feed.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a diagram of an embodiment of an eSAT system including a mobile host computer linked to multiple handheld devices;

FIG. 2 is a diagram of an eSAT network deployed in a military theater of operations;

FIG. 3 is a block diagram of an embodiment of an eSAT network including an enterprise server, a field computer and multiple handheld devices;

FIG. 4 is a diagram of an embodiment illustrating the rendering and display of a 3D model on a host computer and the screencasting of a windowed portion of a visual representation of the 3D model to a handheld device;

FIGS. 5a and 5b are top and perspective views of an embodiment using an UAV to capture 2D images to render the 3D model;

FIG. 6 is a diagram of an embodiment illustrating the use of a handheld device to capture 2D images and transmit the images to the host computer to update the 3D model;

FIGS. 7a through 7c are a sequence of diagrams of an embodiment using a LIDAR platform to geo-rectify the 3D model to geo-coordinates;

FIG. 8 is a diagram of an embodiment using a handheld laser designator to geo-rectify the 3D model to geo-coordinates;

FIG. 9 is a diagram of an embodiment of an eSAT user interface for the host computer;

FIG. 10 is a diagram of an embodiment in which the host computer receives multiple lives feeds from the handheld devices that are displayed in conjunction with the visual representation of the 3D model;

FIG. 11 is a diagram of an embodiment in which the viewpoint of the 3D model on the host computer is slaved to that of a live feed from a handheld device;

FIGS. 12a and 12b are top and perspective views of an embodiment in which the viewpoint of a UAV is slaved to the viewpoint of the 3D model;

FIG. 13 is a diagram of an embodiment of an eSAT client user interface for a handheld device;

FIG. 14 is a diagram of an embodiment illustrating mobile operator interaction with the 3D model at the host computer via the sub-interface;

FIG. 15 is a diagram of an embodiment illustrating mobile operator targeting via the 3D model;

FIGS. 16a and 16b are diagram of an embodiment in which a live feed from a mobile unit is correlated to the 3D model to determine geo-coordinates in a GPS signal-denied environment; and

FIG. 17 is a diagram of an embodiment in which the viewpoint of the 3D model is slated to the current viewpoint of the mobile unit.

### DETAILED DESCRIPTION OF THE INVENTION

The present invention provides enhanced situational awareness and targeting capabilities that push 3D scene awareness and targeting to forward positioned mobile operators and their handheld devices in environments such as found in military theaters of operation, border control and enforcement, police operations, search & rescue and large commercial industrial operations such as mining or road construction.

Existing photogrammetric technologies are limited in their ability to display 3D point clouds on wireless remote handheld devices such as smart phones. The 3D model files are too large to be efficiently transmitted over the wireless networks that support handheld devices. The wireless bandwidth is not sufficient to stream the 3D model files for real-time processing and display by the handheld devices. If transmitted offline and stored as files, the memory requirements on the handheld devices are very demanding and updates to the 3D model cannot be pushed to the mobile operators in a timely manner. Furthermore, storing the 3D model (and other data) on the handheld devices poses a security risk in certain applications. The processing requirements on the handheld devices to manipulate the 3D models are demanding. Lastly, currently available mobile operating systems do not support 3D model viewers. In short, hosting the 3D model on the handheld devices is not supported by current technology.

eSAT circumvents the limitations posed by the 3D model itself, the wireless network and the handheld devices without sacrificing performance or posing a security risk. eSAT accomplishes this by dynamically capturing and transmitting (“screencasting”) a windowed portion of the visual representation of the 3D model at the host computer over a wireless network to the mobile operators' handheld devices. The windowed portion of the visual representation is streamed directly to the operators' handheld device displays. The mobile operators may interact with and control the 3D model via the wireless network. The host computer may synthesize the visual representation of the 3D model with live feeds from one or more of the handheld devices to improve situational awareness. Either the mobile operators or host operator can make point selections on the visual representation to extract geo-coordinates from the 3D model as a set of target coordinates.

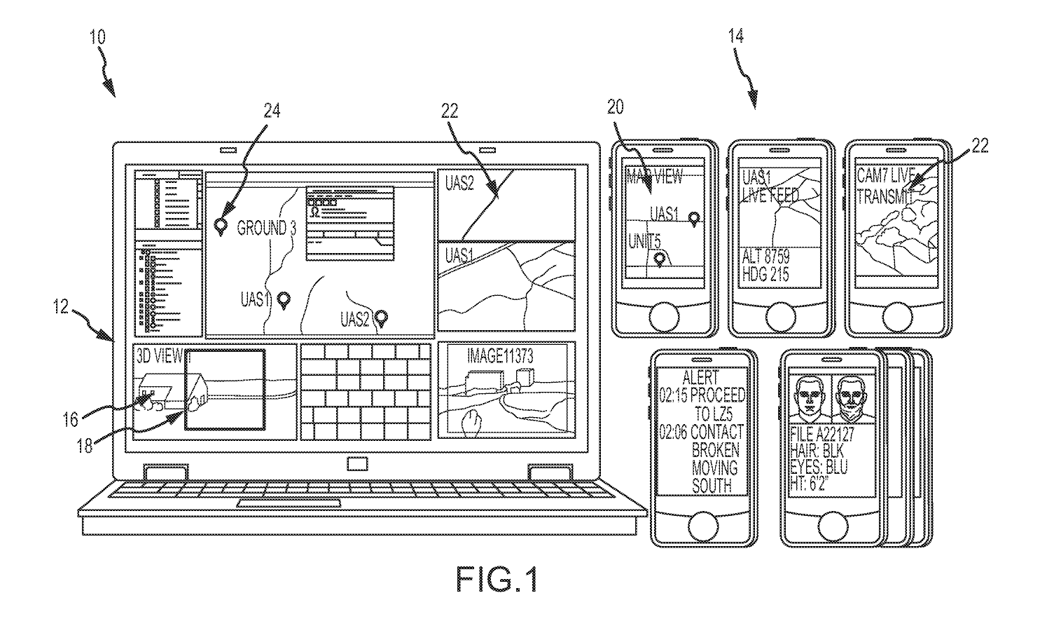

An embodiment of an eSAT system 10 is illustrated in FIG. 1. The eSAT system comprises a host computer 12 (e.g. a laptop computer) linked via a bi-directional wireless network with multiple handheld devices 14 (e.g. smartphones). Other smart hand-held wireless devices having geo-location, image/video capture and display capability perhaps without traditional phone capability may be used in certain operating environments. As used herein handheld devices not only refer to smartphones or enhanced digital cameras but also to mobile devices installed in vehicles, display devices such as projections on glasses or visors, portable 3D projectors, computer tablets and other portable display devices. eSAT software applications on the host computer and handheld device provide a host operator with two-way connectivity to the handheld devices through which video, voice, and data can be exchanged to push information to the individual mobile operators and synthesize information for the host operator.

Host computer 12 hosts a 3D model rendered from images (e.g. 2D or 3D images) of a scene of interest to forward positioned mobile operators provided with handheld devices 14. Host computer 12 may be configured to synthesize images to generate the original 3D model or to update the 3D model in time, spatial extent or resolution. Host computer 12 displays a visual representation 16 of the 3D model from a specified viewpoint. This viewpoint may be selected by the host operator or one of the mobile operators or may be slaved to a live feed of images of the scene from one of the handheld devices or another asset such as a UAV, a robot, a manned vehicle or aircraft or a prepositioned camera. These assets may employ cameras that provide 2D or 3D images.

One or more windows 18 may be placed around different portions of the visual representation. The window(s) may be placed by the host operator or by the host computer in response to a command from a mobile operator, the operator's handheld device or another asset. The host computer dynamically captures the window portion(s) of the visual representation and screencasts the windowed portion(s) to one or more of the handheld devices. The streaming data (e.g. 2D images) may originally appear as a small thumbnail on the handheld display. The mobile operator can open the thumbnail to display the streaming windowed portion 20 of visual representation 16. The data is streamed in real-time or as close to real-time as supported by the computers and wireless network. The screencast data is preferably streamed directly to the handheld display and never stored in memory on the handheld. The handheld devices may be used to capture still or moving images 22 that can be displayed on the handhelds and/or provided as live feeds back to the host computer. The host computer may display these live feeds in conjunction with the visual representation 16 of the 3D model. The host computer may display geo-located markers 24 of the handheld devices or other assets. The mobile operators may also transmit voice, text messages, and emergency alerts back to the host computer and other handhelds. The host computer and handheld devices may support targeting applications that allow the host operator and mobile operators to select points on the visual representation of the 3D model to extract target coordinates.

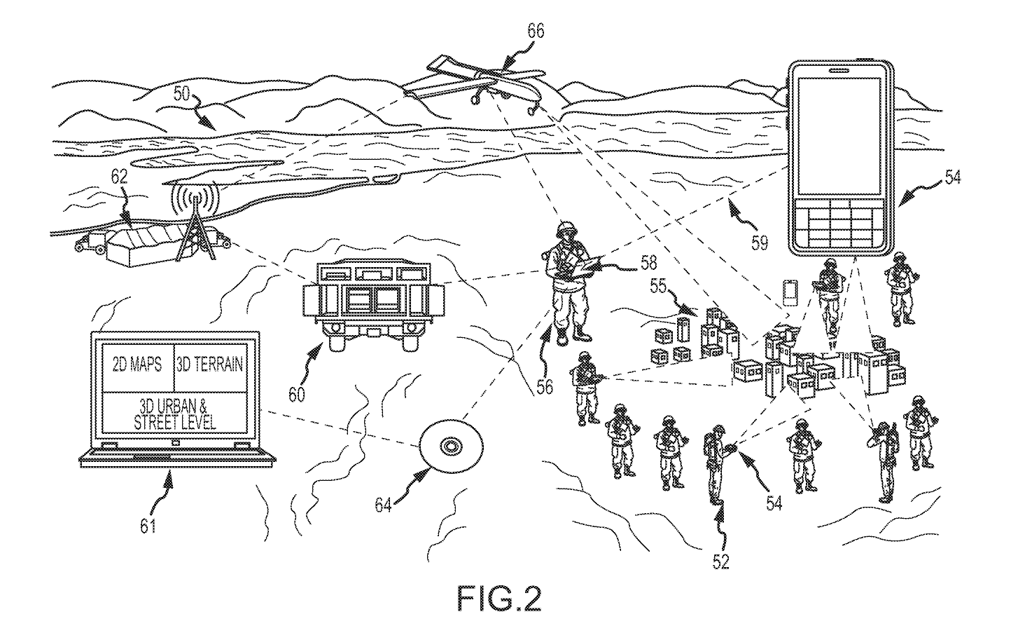

An embodiment of an eSAT network 50 deployed in a military theater of operation is illustrated in FIG. 2. A squad of mobile operators 52 is provided with handheld devices 54 (e.g. smartphones) and deployed to conduct surveillance on and possibly target a rural town 55 (the “scene”). The field commander 56 is provided with a host computer 58 (e.g. a laptop computer). The squad commander and host computer may communicate with the mobile operators and their handheld devices (and mobile operators with each other) over a bi-directional wireless network 59. The wireless network 59 may be established by the deployment of one or more mobile assets 60 to establish a mesh network. In other non-military applications, commercial wireless networks may be used.

In this deployment, eSAT comprises another higher level of capability in the form of an enterprise server 61 (e.g. a more powerful laptop or a desktop computer) at a remote tactical operations center 62. The capabilities of enterprise server 61 suitably mirror the capabilities of the forward positioned host computer 58. Generally speaking enterprise server 61 will have greater memory and processing resources than the host computer. Enterprise server 61 may have access to more and different sources of images to create the 3D model. In certain application, the task of generating the 3D model may be performed solely at the enterprise server 61 and then pushed to the host computer(s). The 3D model may be transferred to the host computer via the wireless network or via a physical media 64. In other applications, the enterprise server 61 may generate an initial 3D model that is pushed to the host computer(s) based on the sources of images available to the enterprise server. Thereafter, the host computer may update the 3D model based on images provided by the forward positioned mobile operators or other airborne assets 66. The images from the forward positioned assets may serve to update the 3D model in time to reflect any changes on the ground, in spatial extent to complete pieces of the model that had yet to be captured or to improve the resolution of the model.

The eSAT network enhances the situational awareness and targeting capabilities of operators at the Tactical Operations Center (TOC), field commander level and the forward positioned mobile operators. eSAT can stream a visual representation of the scene (based on the 3D model) to the forward positioned mobile operators. The viewpoint can be manipulated in real-time by the field command or the mobile operators themselves. Live feeds from the mobile operators (and their geo-locations) are integrated at the host computer to provide the field commander with a real-time overview of the situation on the ground allowing the commander to direct the mobile operators to safely and effectively prosecute their mission. eSAT provides enhanced real-time targeting capabilities, the host operator or mobile operator need only select a point on the visual representation of the 3D model to extract the geo-registered target coordinates.

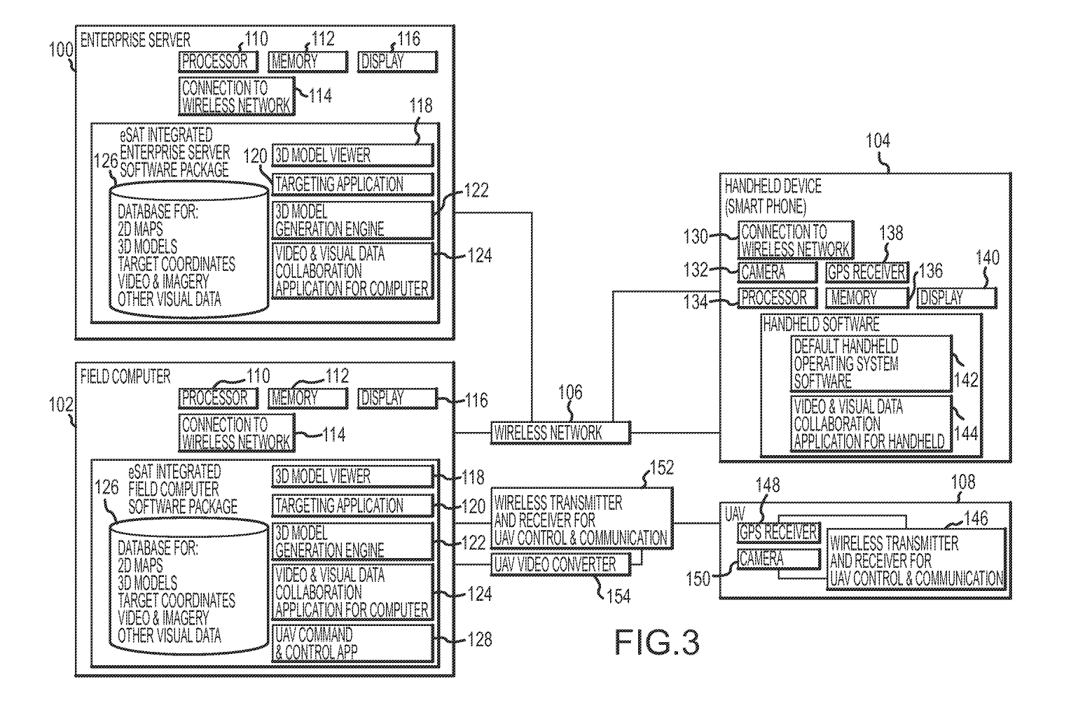

As shown in FIG. 3, an embodiment of eSAT runs on a system comprised of an enterprise server 100, field computer 102, handheld devices (smart phone) 104, wireless network 106, and Unmanned Aerial Vehicle (UAV) 108. The wireless network may, for example, comprise a military or commercial cellular network or 2-way radios.

The enterprise server 100 is comprised of one or more processors 110, one or more physical memories 112, a connection to a wireless network 114, a display 116, and the following software applications: a 3D model viewer 118 such as CloudCaster™ Lite, a targeting application 120, a 3D model generation engine 122 such as GeoSynth™, a video and visual data collaboration application for computer 124 such as including RealityVision® for performance of the screencasting function, as well as a database 126 that contains maps, 3D models, target coordinates, video and imagery, and other visual data. The field computer may comprise a GPS receiver to determine its geo-coordinates. As used herein the term “GPS” is intended to reference any and all satellite positioning based systems. The field computer 102 is comprised of the same components as the enterprise server 100, but with the added UAV command and control application 128. Either the enterprise server or field computer may serve as the host computer.

The handheld device 104 is comprised of a connection to a wireless network 130, a camera 132 (still or video), one or more processors 134, one or more physical memories 136, a GPS receiver 138, a display 140 and the following software: default handheld operating system software 142 and video and visual data collaboration application for handheld 144. The handheld device may or may not include voice capabilities.

In addition to the flight vehicle itself, the UAV 108 is comprised of a wireless transmitter and receiver for UAV control and communication 146, a GPS receiver 148 and a camera 150. The UAV 108 interfaces with a wireless transmitter and receiver for UAV control and communication 152 and UAV video converter 154. In certain embodiments, the UAV may be provisioned with a weapon to prosecute target coordinates. In like manner a manned surveillance aircraft, satellite, missile or other device may be used to provide video and imagery and the like.

On the enterprise server 100, the processor 110, memory 112 and database 126 work together to manage, process and store data. The connection to wireless network 114 interfaces to the wireless network 106 to communicate to the handheld device 104. The 3D model viewer 118 accesses 3D models created by the 3D model generation engine 122 as stored on the database 126 for display on the display 116. The targeting application uses maps, target coordinates and 3D models generated by the 3D model generation engine 122 as stored on the database 126 to generate 3D targeting coordinates used for targeting assets on target. The 3D model generation engine 122 accesses video and imagery from the database 126 to generate 3D models. The video and visual data collaboration application 124 for computer manages receiving of live feeds from the handheld devices 104, as well as the screencasting of 3D models and other visual data accessed from the database 126 as displayed on the display 116 to the handheld device 104 via the wireless network 106. The database 126 stores maps, 3D models, target coordinates, video and imagery, as well as other visual data. In some configurations, the enterprise server may not be provisioned with the capability to screencast the 3D models directly to the handheld devices, instead being required to perform screencasting from the field computer.

The field computer 102 works similarly to the enterprise server 100, except it has the additional functionality of UAV command and control application 128 that controls and manages data received from the UAV 108. In some configurations, field computer 102 may not be provisioned with the 3D model generation engine 122, rather the field computer may simply display and manipulate a 3D model provided by the enterprise server. But in general either the enterprise server or field computer may perform the roll of host computer for the handheld devices.

On the handheld device 104, the connection to wireless network 130 connects to the wireless network 106 to communicate with the enterprise server 100 and field computer 102. The camera 132 records imagery or video. The processor 134 and memory 136 work together to process, manage and display data. The GPS receiver 138 receives GPS location from GPS satellites to report the handheld device's 104 location. The display 140 displays visual information. The default handheld operating system software 142 runs the applications on the handheld device and manages the data and display 140. The video and visual data collaboration application for handheld 144 manages video or imagery from the camera 132 to send a live feed over the wireless network 106 for use by the video and visual data collaboration application for computer 124, and also manages the visual data sent from the video and visual data collaboration application for computer 124 to display on the display 140 as sent over the wireless network 106.

On the UAV 108, the wireless transmitter and receiver for UAV control and communication 146 receives commands from the UAV command and control application 128 over the wireless network 106 to fly to the waypoints as directed by the UAV command and control application 128. The GPS receiver 148 receives GPS position information from GPS satellites to know and report its location over the network 106 to the UAV command and control application 128. The camera 150 records imagery or video, 2D or 3D. The wireless transmitter and receiver for UAV control and communication 152 sends and receives data and commands between the field computer 102 and the UAV 108. The UAV video converter 154 converts video from the camera 150 so it can be used and stored on the field computer 102.

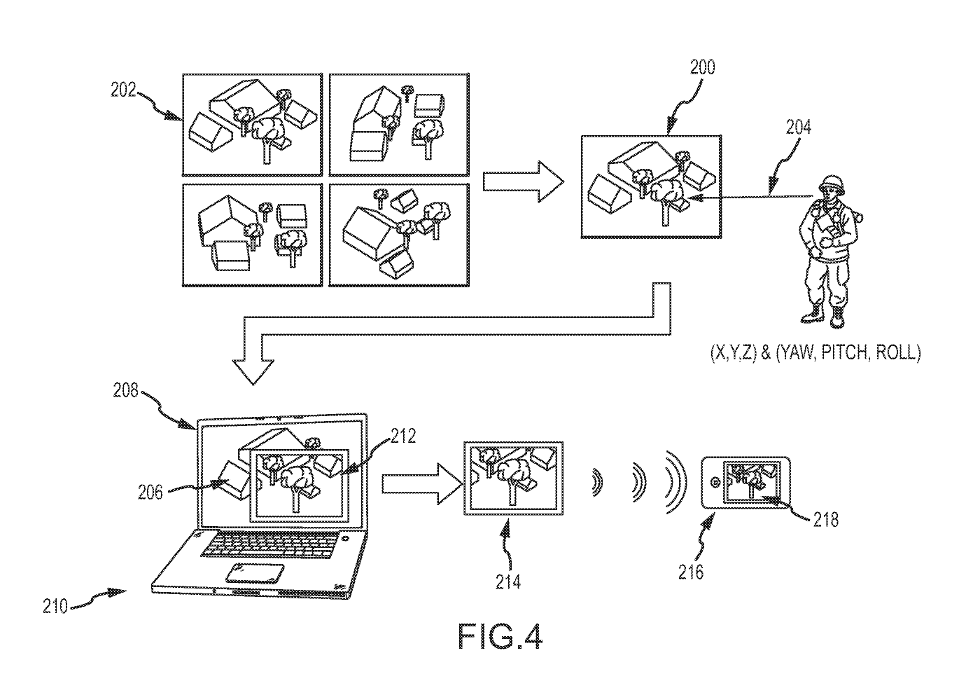

As shown in FIG. 4, eSAT combines 3D scene modeling with dynamic capture of “screenshots” of the 3D model (e.g. screencasting) in order to push situational awareness and targeting capabilities further down an operational hierarchy to the forward most positioned mobile operators. eSAT accomplishes this within the constraints posed by the 3D model, the wireless network, the handheld devices and operational performance requirements and security concerns. This novel combination overcomes the physical constraints of pushing the 3D model itself to the mobile operators for direct manipulation on the handheld devices and overcomes the performance limitations of transmitting static images or video from a fixed viewpoint.

The 3D model generation engine renders a 3D model 200 from 2D images 202 (still or moving) captured from diverse viewpoints about a scene. The camera may capture the images in, for example, the visible band, IR bands including the VNIR, LWIR or SWIR or other spectral bands. The generation engine may render the 3D model from a single band or a hybrid of multiple bands. The “viewpoint” 204 of a scene represents the operator's position and orientation with respect to a fixed 3D model of the scene. The operator's position (x,y,z) may represent geo-coordinates in longitude, latitude and elevation. The operator's orientation may be represented in yaw, pitch and roll. Changing the operator's viewpoint has the effect of panning, scanning, rotating or zooming the view of the 3D model.

The 3D model generation engine may render the 3D model as a 3D “point cloud” in which each point in the cloud is specified by its position (x,y,z) and a color intensity (e.g. R,G,B). GeoSynth™ is one example of such a 3D model generation engine. This technology is described in US 2009/0295791 entitled “Three-Dimensional Environment Created from Video”, which is hereby incorporated by reference. The 3D model generation may alternately render the 3D model as a 3D polygonal model in which individual points are amalgamated into larger polygonal surfaces having pixelized textures. The polygonal model may be rendered directly from the images or from a point cloud such as produced by GeoSynth™. The polygonal model is more complex to generate but is more efficient to display, manipulate and transmit.

The 3D model viewer displays a visual representation 206 of the 3D model from a given viewpoint on the display 208 of the host computer 210. The viewer represents the 3D model onto the display, typically a 2D display but possibly a 3D display. The manipulation of the viewpoint provides for the 3D characteristics of the modeled scene. GeoSynth™ provides a 3D model viewer. Other viewers such as CloudCaster™ Lite may be used to view the point cloud. The viewer allows the host operator to change the viewpoint via an input device such as a mouse or stylus or via a touchscreen display.

The collaboration application allows the host operator (or host computer in response to a command) to place a window 212 about a portion (some or all) of the visual representation 206 of the 3D model. The window may encompass other host data such as application buttons. The application dynamically captures the visual representation (and any other data) inside the window at a refresh rate and streams the windowed portion 214 of the visual representation over the wireless network to one or more of the handheld devices 216. Although the sources of the visual representation and other data within the window may be disparate in format, the viewer renders them and the application transmits them in a common format (e.g. a 2D image format). The refresh rate may or may not be at standard video rates. The bandwidth required to stream the windowed portion of the visual representation is far less than would be required to transmit the entire 3D model in real-time to the handheld devices.

The applications may simply broadcast the windowed portion 214 of the visual representation to all handheld devices that are part of the host computer's network or may allow the host computer to select individual operators, subsets of operators or all operators to receive a particular stream. The application may allow the host operator (or host computer) to place multiple windows over different portions of the same visual representation and stream those multiple windows to the same or different operators. Alternately, the application may support displaying multiple visual representations of the 3D model from different viewpoints in different windows and streaming those portions of the visual representations to the same or different operators.

The handheld device's client collaboration application may, for example, initially stream the windowed portion 214 of the visual representation to a small thumbnail on the handheld display, possibly provided with some visual indicator (e.g. caption or color) as to the source or content of the feed. Multiple thumbnails may be displayed concurrently. The mobile operator selects which visual stream 218 the operator wants to view.

In an embodiment, the windowed portion of the visual representation is only streamed directly to the handheld device; it is not stored on the handheld device. Streaming provides real or near-real time rendering of the visual representation with minimal operator interaction. Streaming reduces the demands on both processing capabilities and memory of the handheld device. Streaming also eliminates the chance that proprietary information could be lost if the handheld device was compromised. In certain configurations, no operational data is stored on the handheld device. In other embodiments, it may be desirable to store the visual representation in the handheld device.

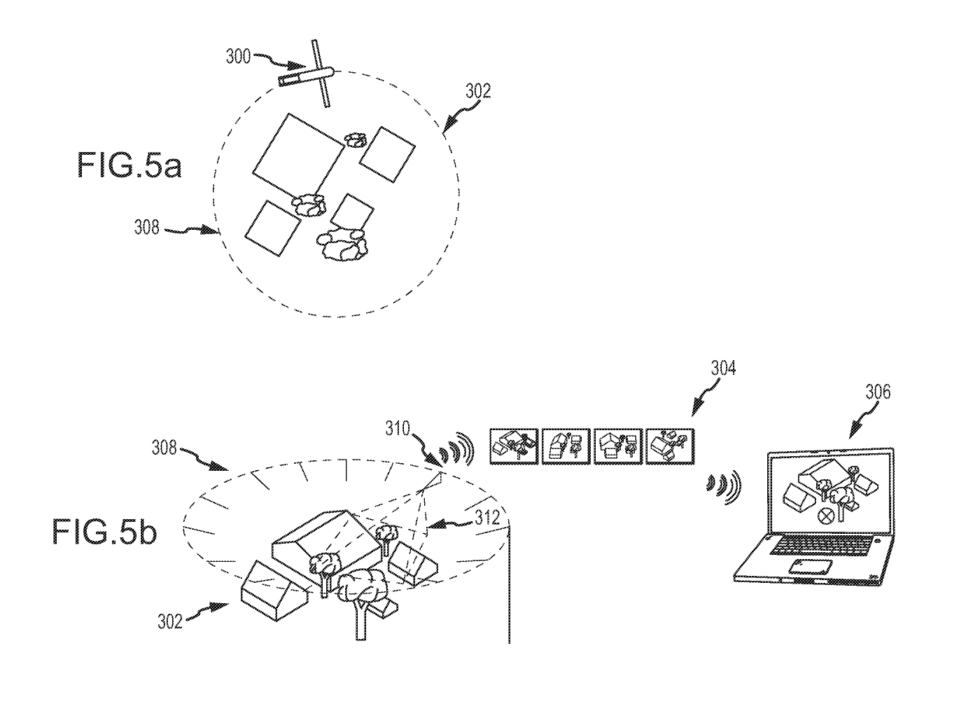

As shown in FIGS. 5a and 5b, in an embodiment an airborne asset 300 (e.g. satellite, manned airplane or helicopter or unmanned airplane or helicopter) flies above and around a scene 302 to capture a sequence of images 304 from diverse viewpoints. The asset may use either a 2D or 3D camera. The images 304 are transferred to a computer 306 (e.g. the enterprise server or the field computer) to process the images and generate the initial 3D model. The images may be transferred in real-time as captured over a wireless network or downloaded offline camera's memory card.

To efficiently capture images to generate a 3D model from diverse viewpoints and adequate resolution, the airborne asset 300 traverses an overhead flight path 308 that is a full 360° orbit in order to get all 360° viewpoints surrounding the scene. An orbit of less than 360° results in dropouts (no data) from viewpoints where no images were obtained. Orbit radius depends on the size of the scene to be modeled. The camera pitch 310 is set to capture subjects of interest in the scene.

The camera field of view (FOV) 312 affects both the resolution and size of modeled scene. A larger FOV will allow modeling a larger scene in 3D. However, larger FOV's reduce resolution of the 3D model. Smaller FOV's increase resolution but reduce size of scene to be modeled in 3D. A mix of overlapping large and small FOV's will allow a large scene and good resolution in the 3D model. The altitude of flight path 308 and the FOV 312 work together to affect the resolution and size of the 3D model. Higher altitude has the same effect as a larger FOV and lower altitude has the effect of a smaller FOV.

The images 304 are recorded at intervals along the circular orbit 308 to obtain enough images for good scene-to-scene correlation for the 3D model. Fewer images reduce the quality of 3D model by increasing the number of points that dropout in the point cloud. More images increase quality but also increase the time to gather and process the images into the 3D point cloud model.

In a particular embodiment, the flight path 308 is a full 360° orbit with an orbit radius approximately 10% larger than the radius of a circle projected onto the ground that covers the entire scene. The camera pitch is set to image the center of the orbit circle projected on ground. The camera FOV is set at maximum. The altitude is radius×tan 30° with a maximum altitude up to 1000 feet. The camera records images at every 6° of arc along the circular orbit.

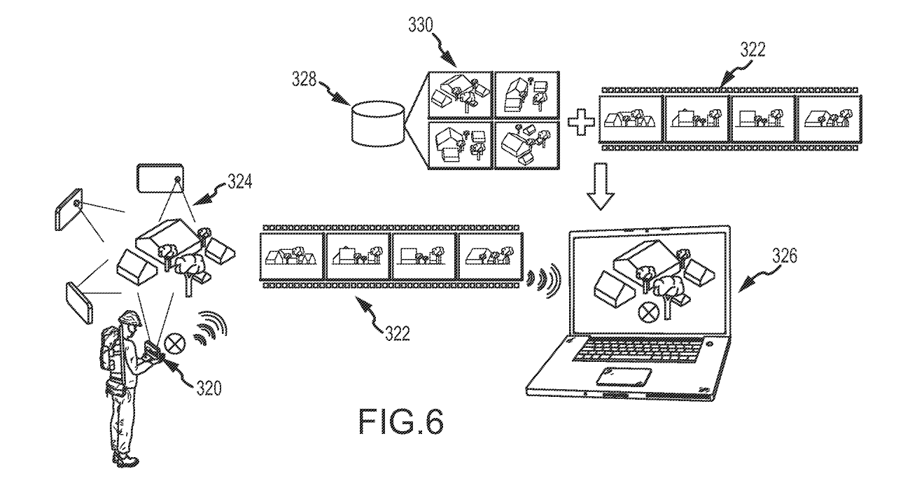

As shown in FIG. 6, in an embodiment the forward positioned mobile operators may use their handheld devices 320 to capture images 322 of the scene 324 and transmit the images over a wireless network to the host computer 326 to augment the database 328 of existing images 330 of the scene. The host computer processes the new images 322 into 3D model data and integrates the data to update the 3D model in time, spatial extent or resolution. For example, the scene may have changed since the original model was generated by the enterprise server and pushed out to the field host computer. The original assets may not have been able to provide all the images required to allow the 3D model to be fully rendered from all viewpoints. The forward positioned mobile operators may be able to visualize missing pieces of the model to increase or complete the spatial extent of the model. The forward positioned mobile operators may be able to capture images of the scene with higher resolution than the original enterprise assets.

To display the visual representation of the 3D model from geo-accurate viewpoints the 3D model needs to be geo-registered in scale, translation and rotation. Geo-coordinates of latitude, longitude and elevation and by convention specified as (x,y,z). Geo-accurate is considered to have a 5 m accuracy or better. Geo-rectification is the method by which a 3D model becomes geo-registered. Manual techniques can and are used to geo-register 3D point clouds. However, these techniques are labor intensive and do not ensure geo-accurate positioning.

To achieve geo-accurate registration, the geo-rectification method uses laser position-sensing techniques from aerial or terrestrial platforms. The aerial platform could be a manned or unmanned airplane or helicopter. The terrestrial platform could be a soldier's laser designator or a surveyor's laser range finding tool with angle capability. The technique uses a laser from a platform having known geo-coordinates to lase at least three points of interest in the scene to extract precise geo-coordinates of those at least three points. These three or more geo-located points are used to fix the scale, translation and rotation of the 3D model in (x,y,z) geo-coordinates.

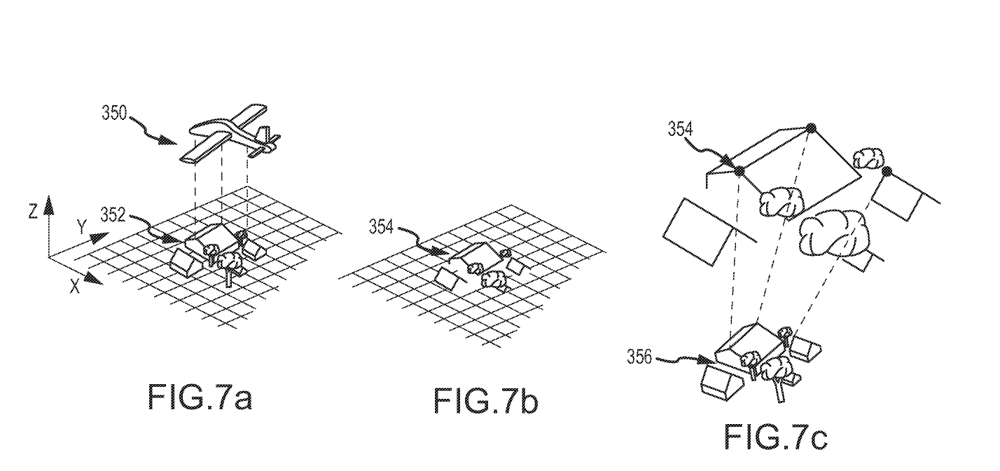

As shown in FIGS. 7a through 7c, an airborne LIDAR (or LADAR) system 350 provides the platform for laser positioning points of interest in a scene 352. LIDAR or LADAR data from the overhead asset of scene 352 is used to extract precise coordinates in three dimensions (x, y, z) for at least three points 354 in the 3D scene. If absolute geo-location of the overhead asset is known, then the three (or more) points from the scene can have known absolute geo-locations. These three (or more) geo-located points 354 are then used to geo-position the 3D model 356 generated from the 2D images adjusting and locking-down the i) scale, ii) translation and iii) rotation about x, y and z.

LIDAR or LADAR is used to position the point clouds obtained from 2D photos because of LIDAR/LADAR accuracy in three dimensions. However, LIDAR or LADAR point clouds from overhead assets only show the heights of the tops of objects; in other words, these point clouds lack data from the sides of objects (i.e. sides of buildings, windows, doors). The benefit of LIDAR/LADAR point clouds to 3D point clouds generated from 2D photos is the three dimensional position accuracy of points inherent in LIDAR/LADAR datasets. This accuracy is used to anchor the 3D point clouds generated from 2D photos, since these point clouds may lack absolute three dimensional geo-registration, depending on the metadata included in 2D photos.

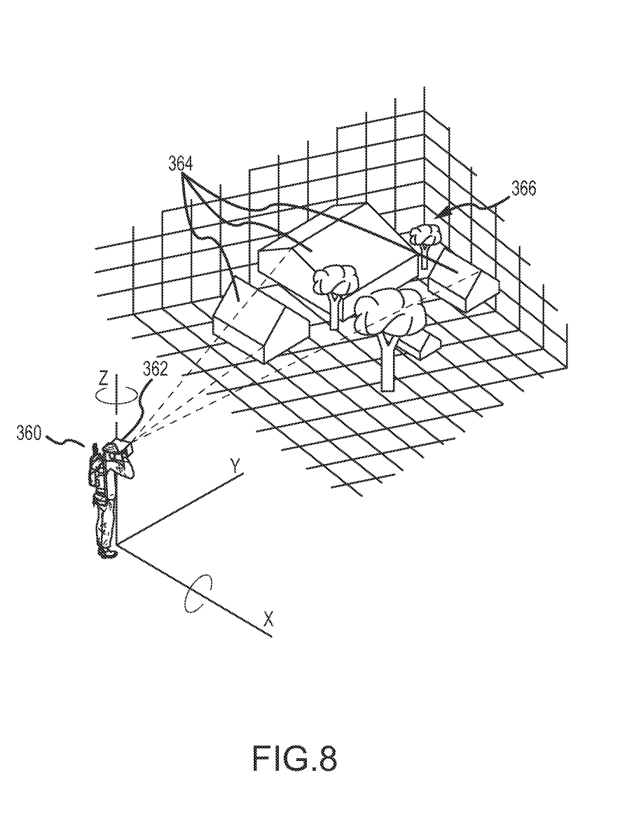

As shown in FIG. 8, an operator 360 may use a laser rangefinder 362 with angle measurement capability to pick three points 364 in a scene 366. The rangefinder records the range to a chosen feature, elevation angle (about x-axis), and azimuth angle (about z-axis) for each of the three points. Assuming the absolute geo-location of the operator is known, the absolute geo-locations of the three points from the scene can be calculated from the range, elevation and azimuth measurements of each point. These three geo-located points are then used to geo-position the 3D model, adjusting and locking-down the i) scale, ii) translation and iii) rotation about x, y and z.

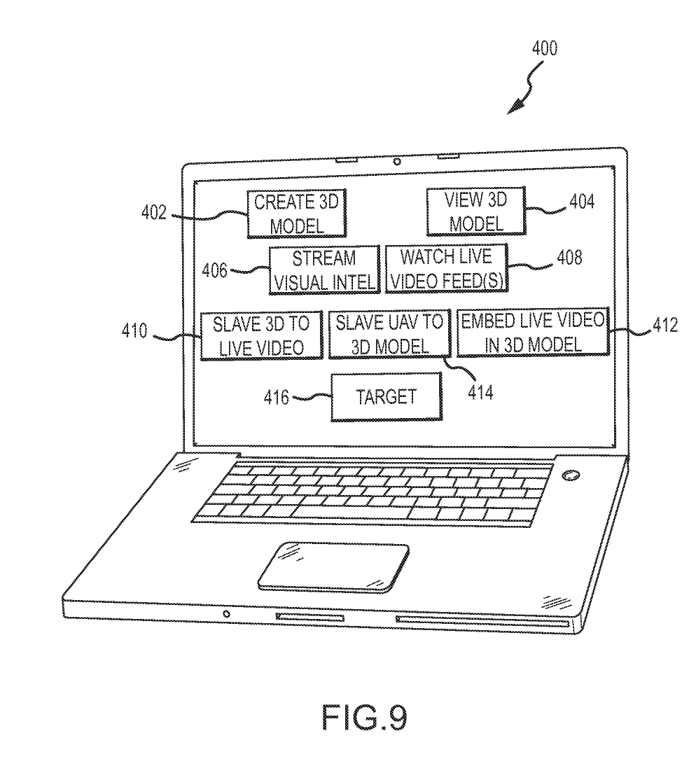

As depicted in FIGS. 9-12, the host computer's collaboration application allows the host computer and host operator to both manage distribution of scene information via the 3D model to the mobile operators and to synthesize multiple sources of information including the 3D model and live feeds from the mobile operators and other mobile assets.

FIG. 9 is a depiction of a top-level operator interface 400 for an embodiment of the collaboration application. The interface includes buttons that allow the host operator to launch different modules to perform eSAT tasks. A “Create 3D Model” button 402 launches an interface that allows the operator to select the images of interest and then launches the 3D model generation engine to generate (or update) the 3D point cloud from the images. Instead of operator selection, the interface could be configured to automatically process images from specified sources for a selected scene. A “View 3D Model” button 404 launches the 3D model viewer that allows the operator to interact and manipulate the viewpoint to effectively pan, zoom and/or rotate the 3D point cloud to reveal the 3D aspects of the scene. A “Stream Visual Intel” button 406 launches the dynamic streaming capability. A window is placed around a portion of the visual representation of the 3D model from its current viewpoint and the application captures and dynamically streams the contents of the window at a refresh rate. The operator may elect to direct the stream to a subset or all of connected mobile devices. The operator (or host computer) may elect to place multiple windows on different portions of the same visual representation and stream the contents of those windows to the same or different subsets of the mobile operators. Alternately, the operator (or host computer) may launch multiple instances of the viewer from different viewpoints, place windows on each and stream the contents of the different windows to the same or different subsets of the mobile operators. A “Watch Live Video Feed(s)” button 408 launches an interface to let the host operator select which live video feeds from mobile operators or other assets the operator desires to watch. The host operator may elect to “slave” the viewpoint of the model to a live feed from one of the mobile operator's handheld devices or from another asset using a “Slave 3D to Live Feed” button 410. An “Embed Live Video in 3D Model” button 412 launches an application that embeds one of the live feeds in the visual representation of 3D mode. The viewpoint of the 3D model may be slaved to that live feed. A “Slave UAV to 3D Model” button 414 launches an application that slaves a viewpoint of a UAV to obtain 2D images to the current viewpoint of the 3D model. The current viewpoint of the 3D model may be host operator selected, mobile operator selected or slaved to another asset. The images from the UAV may be transmitted to the host computer and displayed as a live feed or used to update the 3D model. A “Targeting” button 416 launches an application that allows the host operator to select a point target on the visual representation of the model or one of the live feeds. The application matches the point selection to the geo-accurate geo-coordinates of the 3D model and may transmit the coordinates to deploy an asset to the target. If a point on a live feed is selected, the application first correlates the live feed to the 3D model and then extracts the target coordinates. The described buttons are but one configuration of an interface for the host computer collaboration application. Other button configurations and additional application functionality directed to enhancing the situational awareness and targeting capabilities of the host operator and mobile operators are contemplated within the scope of the present invention.

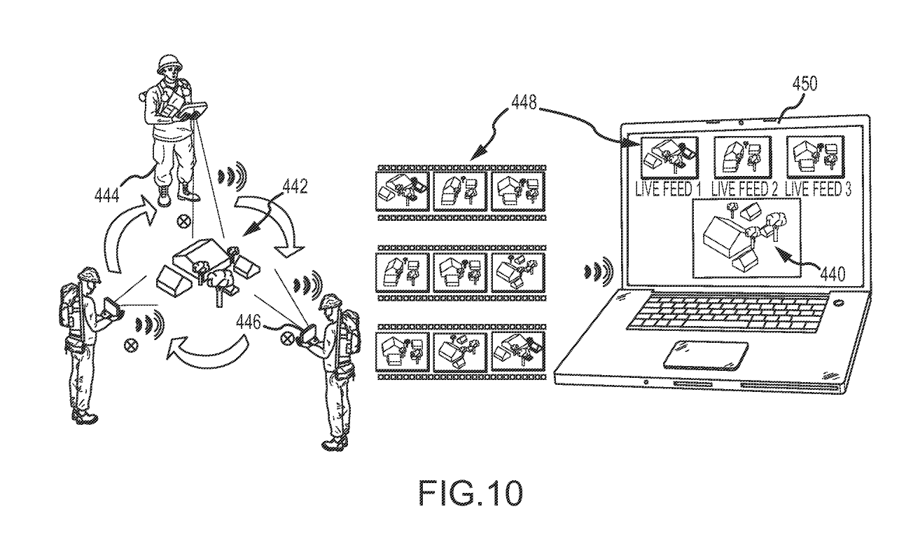

An embodiment of a combination of the “View 3D Model” and “Watch Live Video Feed(s)” is depicted in FIG. 10. The View 3D Model application displays a visual representation 440 of the 3D model of a scene 442 from a specified viewpoint. Mobile operators 444 use their handheld devices 446 to capture live feeds 448 of scene 442 from different viewpoints and transmit the live feeds over the wireless network to the host computer 450. The live feeds are not stored on the handheld devices, only streamed to the host computer. The host computer 450 may display each live feed as a thumbnail with an indicator of the source mobile operator. The host operator can then select one or more thumbnails and open a larger window to display the live feed 448. GPS coordinates of the mobile operators' handheld devices (denoted by “circled-Xs”) are also transmitted to the host computer. The host computer displays the circle-X marker on the visual representation of the 3D model to denote the location of the mobile operator. The host computer updates the position of the circle-X as the transmitted GPS coordinates of the operator change. The circle-X and its associated live feed may be captioned or color coded so that the host operator can easily discern which live feed corresponds to which mobile operator. The host computer may also process the live feeds to generate 3D model data to generate the initial 3D model or to update the 3D model as previously described.

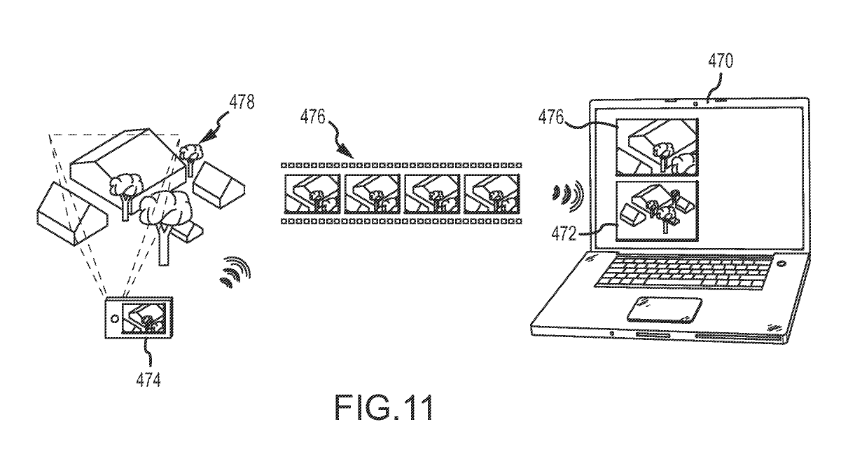

An embodiment of a combination of the “View 3D Model”, “Watch Live Video Feed(s)” and “Slave 3D to Live Feed” is depicted in FIG. 11. A host computer 470 slaves the viewpoint of the 3D model displayed in visual representation 472 to the current viewpoint of a mobile operator's handheld device 474. The mobile operator uses the handheld device to capture a live feed 476 of the modeled scene 478 and stream the live feed 476 over the wireless network to the host computer. The host computer displays live feed 476 in conjunction with visual representation 472 of the 3D model slaved thereto. The host computer may embed live feed 476 within visual representation 472. The computer may determine the current viewpoint of the handheld device either by receiving the viewpoint (position and orientation) from the handheld device or by correlating the live feed to the 3D model and extracting the current viewpoint. The host computer may display the live feed 476 next to the visual representation of the 3D model or may embed the live feed 476 into the visual representation 472 with the live feed geo-registered to the visual representation of the 3D model. The host operator may launch the “Targeting” application and select point targets from either the visual representation 472 of the 3D model or the live feed 476.

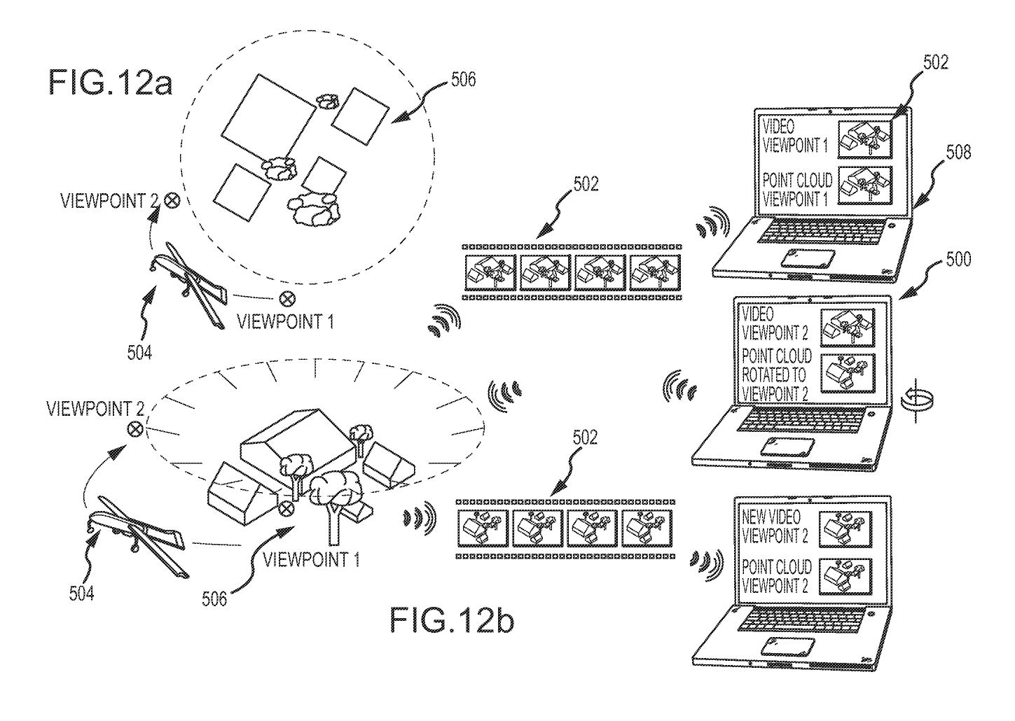

An embodiment of a combination of the “View 3D Model”, “Watch Live Video Feed(s)” and “Slave UAV to 3D Model” is depicted in FIGS. 12a and 12b. A host computer 500 receives a streaming live feed 502 from a UAV 504 flying above a modeled scene 506. The host computer sends a command 507 via the wireless network to slave the viewpoint of the UAV to current viewpoint of the 3D modeled displayed in a visual representation 508. The host computer may generate this command in response to host operator or mobile operator manipulation. In response to the command, UAV 504 moves from its current viewpoint (Viewpoint1) to a new viewpoint (Viewpoint2).

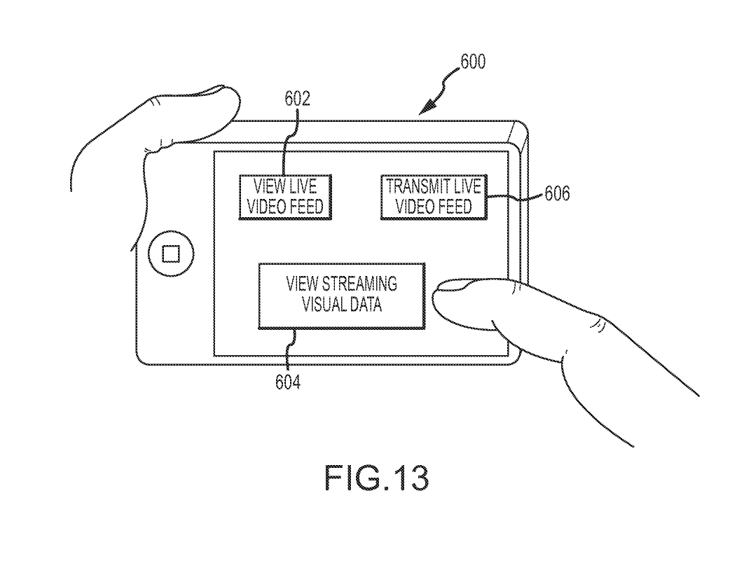

As depicted in FIGS. 13-15, the handheld device's client collaboration application allows the handheld device and mobile operator to both interact with the 3D model via the wireless network and to provide live feeds to the host computer.

FIG. 13 is a depiction of a top-level mobile operator interface 600 for an embodiment of the client collaboration application. The interface includes buttons that allow the mobile operator to launch different modules to perform eSAT tasks. The described buttons are but one configuration of an interface for the client collaboration application. Other button configurations and additional application functionality directed to enhancing the situational awareness and targeting capabilities of the mobile operators are contemplated within the scope of the present invention.

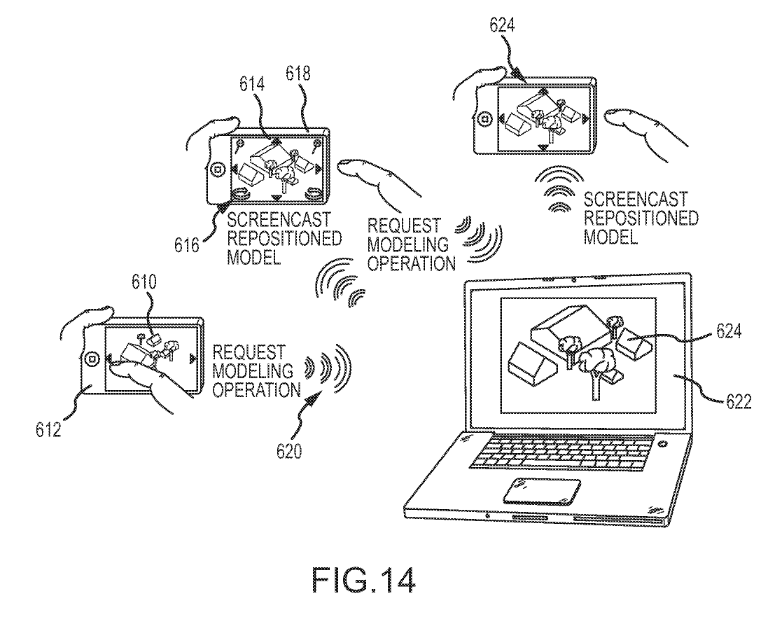

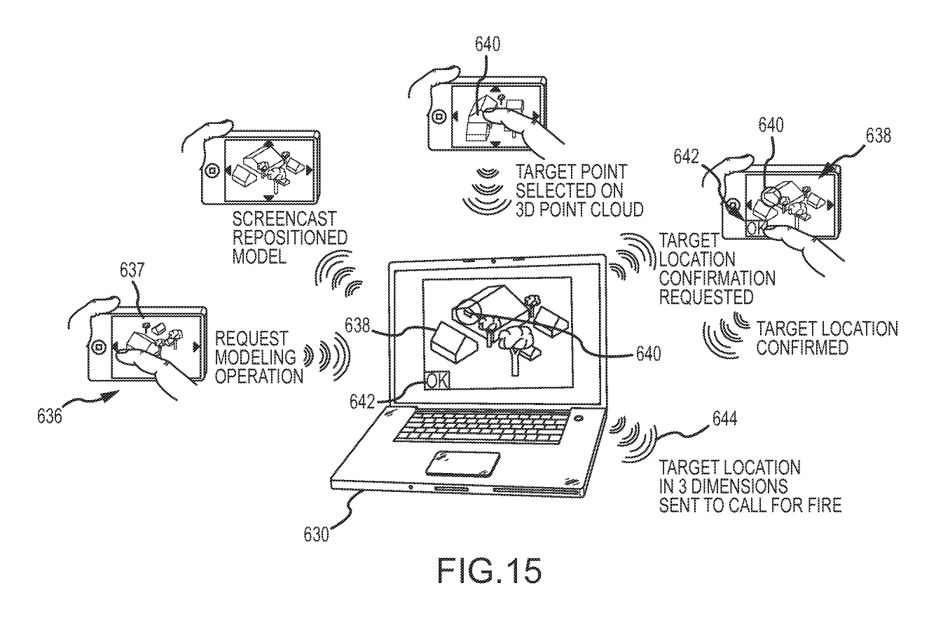

From the home screen, a mobile operator can select from three buttons. Selection of a “View Live Video Feed” button 602 displays links (e.g. thumbnails of the live videos or a caption) to any cameras that are transmitting on the eSAT network (including the mobile operator's own camera), with the links then displaying the live feeds from the camera. Selection of a “View Streaming Visual Data” button 604 allows the mobile operator to choose from a list of 3D models (or different viewpoints of a 3D model) that are being streamed over the eSAT network. As will be illustrated in FIGS. 14 and 15, when viewing the windowed portion of the visual representation of the 3D model on the handheld device display the mobile operator can interact with and manipulate the viewpoint of the 3D model and can perform targeting functions. Selection of a “Transmit Live Video Feed” button 606 which transmits live video from the phone's camera to central server for viewing and archiving.

As shown in FIG. 14, when viewing a visual representation 610 of a 3D model on a handheld device display 612, the mobile operator can select how to manipulate the viewpoint of the 3D mode to reveal the 3D nature of the scene. In this configuration, the mobile operator may use arrows 614 to pan, curved arrows 616 to rotate, and magnifying glasses 618 to zoom in or out. In response to mobile operator manipulation of the viewpoint, the client operation generates a command 620 that is transmitted over the wireless network to a host computer 622. The host computer manipulates the viewpoint of the 3D model to change visual representation 624 at the host. The host then streams the windowed contents of updated visual representation 624 via the wireless network to the handheld device. The mobile operator may repeat this process to interact with the 3D model via the wireless network.

As shown in FIG. 15, a host computer 630 displays a visual representation of a 3D model on host computer display. The host screencasts the windowed portion of the visual representation over a wireless network to a handheld device 636 where it is displayed as streaming visual data 637. From the handheld device, the mobile operator interacts with the host computer to position the viewpoint of the 3D point cloud to the orientation desired by the mobile operator. The host computer screencasts a repositioned visual representation 638 of the 3D model. The mobile operator then selects a point target 640 on the visual representation 638 of the 3D model. The handheld device wirelessly transmits the coordinates of the selected point to the host computer. The host computer matches the selected point target to a 3-dimensional geo-coordinate in the 3D model and highlights its interpretation of the selected point on the visual representation 638 of the 3D model on the host computer display. The host computer screencasts the highlighted three-dimensional point 640, along with a confirmation prompt 642, to the handheld display. The mobile operator now sees the freshly repositioned windowed portion of the visual representation of the 3D model 638, the highlighted position 640 in the 3D model and the confirmation prompt 642 as streamed visual data on the handheld's display screen. None of this data is stored on the handheld device, only received as “screencast” streamed visual data. The mobile operator confirms the target location as correct, or repeats the aforementioned process until the location is correct, based on what mobile operator sees in real time in the real scene. The host computer forwards the three-dimensional targeting coordinates 644 to request assets (weapons or sensors) be deployed on the target's 3D coordinates.

eSAT can be used to provide image-assisted navigation in GPS signal-denied environments. Either the forward positioned host computer or the mobile operator's handheld device captures a live feed of the scene and correlates the live feed to the 3D model to estimate the current viewpoint, hence the geo-coordinates of the host computer or handheld device. The visual representation of the 3D model may be slaved to the current viewpoint of the host computer or handheld device and displayed with the live feed.

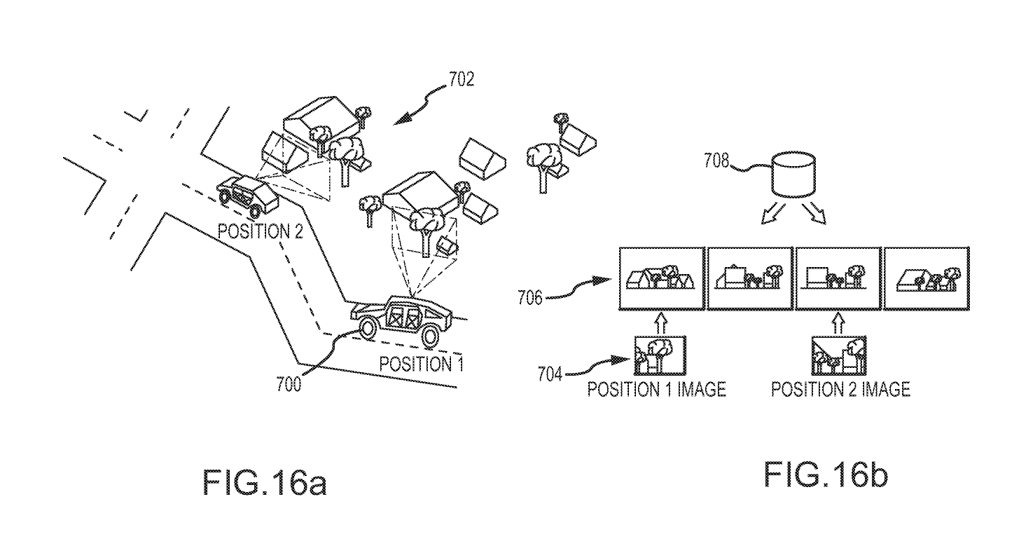

As shown in FIGS. 16a and 16b, in an embodiment as a vehicle 700 drives through a modeled scene 702 such as village from Position 1 to Position 2, a camera captures images 704 of the scene. The host computer compares the images against the geo-registered images 706 stored in a database 708 in 3D registration in the 3D model to determine the current viewpoint, hence position of the vehicle. The database search is suitably constrained to a “ballpark” set of images by an inertial measurement unit (IMU) on board the vehicle that “roughly” knows the vehicle's location in the village. The host computer refreshes the vehicle's location at a pre-determined update rate.

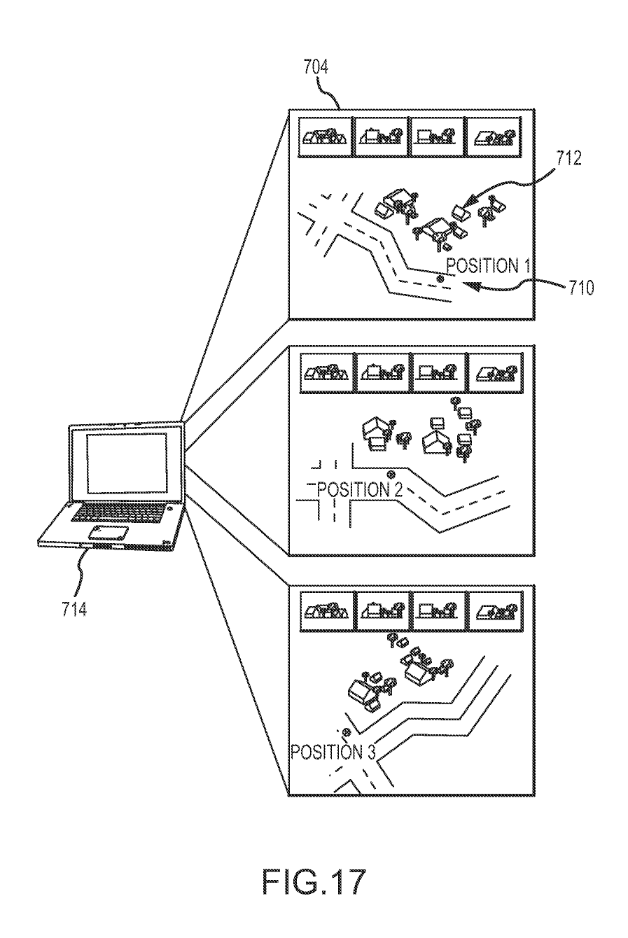

As shown in FIG. 17, as the vehicle drives through the village, the viewpoint of the 3D model is slaved to the viewpoint of the vehicle and the images 704. The vehicle's location is continually updated at a pre-determined update rate and displayed as an icon 710 on visual representation 712 of the 3D model on the host computer 714. The 3D model is simultaneously rotated and panned to follow the location of the vehicle from a bird's eye perspective.

The platform of capabilities provided by eSAT can be leveraged in many environments such as found in military theaters of operation, border control and enforcement, police operations, search & rescue and large commercial industrial operations. Deployment of eSAT to improve situational awareness and targeting in a military theater of operations will now be described.

### Mission Planning & Rehearsal

For detailed mission planning and rehearsal eSAT provides a collection of unique and integrated capabilities that greatly enhance the warfighter's ability to collect, organize, sort/search, stream imagery, and rapidly synthesize 3D terrain and urban models from a wide variety of sources. Together, these enhancements deliver image and intelligence processing capabilities previously held at the strategic and theater level down into the lowest level of mission planning.

A military unit poised to enter an unfamiliar area (village or other area of regard) can use eSAT to perform mission rehearsal and mission planning prior to entering the unfamiliar area. Soldiers can use the 3D model to perform a virtual walk-through or virtual fly-by of an unfamiliar area. A field commander can push views of the 3D model to soldiers using the screencasting capability. The 3D model may be used in conjunction with weapons models to simulate attacks on or by the soldiers and blast damage to target and collateral areas. The 3D model can be used to determine dangerous areas (e.g. snipers, IEDs) during the walk-through and to build in “alerts” to the mission plane

### Mission Execution

eSAT may be used to stream different viewpoints of the 3D model to forward positioned soldiers of an area on-the-fly as the soldiers are preparing to enter the area or are already embedded in the area. For example, soldiers may just want a refresher about what a 3D village scene and buildings look like from an immersed ground perspective just prior to entering the village gates. Or, a soldier may want to know what the village looks like from another viewpoint, say for example, “I′m currently looking at building A from the front view . . . what's the view look like from behind building A?” Manipulating the 3D models from a handheld device enables the soldier to “see” what the scene looks like from a different vantage point. The field commander can use the host computer to synthesize views of the 3D model with live feeds from the forward deployed soldiers and other mobile assets. This provides the field commander with real-time close-in intelligence of the scene as operations are developing to provide information and orders to the soldiers to accomplish the mission while safeguarding the soldiers.

### Targeting

eSAT provides enhanced targeting capabilities to both the field commander and the forward most deployed soldiers. The basic targeting capability allows the field commander or soldier to make a point selection on the visual representation of the 3D model. The point selection is then correlated to the model to extract the geo-coordinates. The host computer may then transmit the target coordinates to fire control to deploy an asset to the specified target coordinates. This “point and click” capability is simpler and more accurate than having the field commander or soldier provide a verbal description of the target area over a voice channel. eSAT can provide other enhanced targeting capabilities such as the ability to use the 3D model to determine direct line-of-sight to target coordinates or to guide inbound munitions or UAVs to avoid obstacles in the scene. The 3D model can be used to model blast damage to a target and the collateral damage prior to launching the munition. The modeling may be used to select the appropriate munition and attack plan to destroy the target while minimizing collateral damage. The 3D model may be used to display the available friendly weapons coverage and time-to-target.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

We claim:

1. A method of providing enhanced situational awareness to a host operator and one or more forward positioned mobile operators, comprising:
providing a host computer with a three-dimensional (3D) model rendered from images of a scene, said 3D model capable of geometric manipulation from different viewpoints;
displaying a visual representation of the 3D model from a specified viewpoint on a host computer display, said host computer configured to allow host operator manipulation of the 3D model to change the viewpoint;
dynamically capturing a first windowed portion of the visual representation of the 3D model at a given refresh rate; and
streaming the first windowed portion of the visual representation over a wireless network to the handheld devices of one or more mobile operators forward positioned in the vicinity of the scene, said handheld devices configured to allow mobile operator selection to stream the first windowed portion of the visual representation to a handheld device display.

2. The method of claim 1, further comprising:
from a platform of known geo-coordinates, laser position sensing at least three points from the scene to extract geo-coordinates for each of the at least three points in the 3D model; and
using the extracted geo-coordinates, geo-rectifying the 3D model to geo-coordinates to geo-register the 3D model in scale, translation and rotation and displaying the visual representation of the 3D model from geo-accurate viewpoints.

3. The method of claim 2, wherein the platform comprises an airborne asset with an overhead view of the scene or a terrestrial asset with a side view of the scene.

4. The method of claim 1, further comprising:
receiving images of the scene from forward positioned mobile assets; and
processing the received images into 3D model data at the host computer and integrating the data to update the 3D model in time, spatial extent or resolution.

5. The method of claim 4, wherein the forward positioned mobile units comprise one or more of the mobile operators' handheld devices, said handheld devices configured to capture still or moving images and transmit the images over the wireless network to the host computer.

6. The method of claim 1, wherein the step of providing the 3D model, comprises:
flying a forward positioned unmanned aerial vehicle (UAV) with a camera above the scene at diverse viewpoints to record and provide images directly to the host computer to render the images into the 3D model.

7. The method of claim 6, further comprising:
slaving the viewpoint of the visual representation of the 3D model to the current viewpoint of the UAV.

8. The method of claim 1, further comprising:
displaying a second visual representation of the same 3D model from a different viewpoint on the host computer display;
dynamically capturing a second windowed portion of the second visual representation of the 3D model at a given refresh rate; and
streaming the second windowed portion of the second visual representation over a wireless network to the handheld devices of one or more mobile operators forward positioned in the vicinity of the scene, said handheld devices configured to allow mobile operator selection of the second window to stream the second windowed visual representation in real-time to the handheld device display.

9. The method of claim 1, further comprising:
dynamically capturing a second windowed portion of the visual representation from the specified viewpoint at the given refresh rate, said second windowed portion of the visual representation different from said first windowed portion of the visual representation; and
streaming the second windowed portion of the visual representation over the wireless network to the same or different one or more of the handheld devices of the mobile operators.

10. The method of claim 1, further comprising:
said one or more forward positioned mobile operators capturing live feeds of images of the scene and transmitting the live feeds over the wireless network to the host computer; and
displaying the one or more live feeds in one or more additional windows on the host computer display in conjunction with the visual representation of the 3D model.

11. The method of claim 10, further comprising:
slaving the viewpoint of the visual representation of the 3D model to the current viewpoint of one of the live feeds.

12. The method of claim 11, further comprising:
embedding the display of the live feed to which the visual representation is slaved within the visual representation.

13. The method of claim 10, further comprising:
obtaining the geo-coordinates of at least each of the forward positioned mobile operators' handheld devices transmitting the live feeds; and
displaying a geo-positioned marker for each of the geo-located mobile operators within the visual representation of the 3D model.

14. The method of claim 1, further comprising:
host operator selection of a single point on the visual representation of the 3D model to extract geo-coordinates from the 3D model; and
transmitting the geo-coordinates of said point as a set of target coordinates to deploy an asset to the target coordinates.

15. The method of claim 1, further comprising:
one or more said forward positioned mobile operators generating a 3D model manipulation command from their handheld devices based on the streamed first windowed portion of the visual representation of the 3D model;
transmitting the one or more model manipulation commands over the wireless network to the host computer;
said host computer executing the one or more model manipulation commands on the 3D model to display visual representations of the 3D model in accordance with the commands; and
streaming the first windowed portion of the visual representation back to at least the requesting forward mobile operator.

16. The method of claim 15, wherein said host computer executes multiple model manipulation commands in a time sequence and streams the first windowed portions of the visual representations back to at least the requesting forward mobile operator sequentially.

17. The method of claim 15, wherein said host computer executes multiple model manipulation commands in parallel displaying different visual representations of the model in different windows on the host computer display and streams the respective first windowed portions of the visual representations back to the respective requesting forward mobile operators concurrently.

18. The method of claim 15, wherein icons for one or more host computer applications are dynamically captured by the first windowed portion of the visual representation streamed to the handheld displays, further comprising:
mobile operator selection of an icon on the handheld display to generate an application command;
transmitting the application command over the wireless network to the host computer;
said host computer executing the application command to update the visual representation; and
streaming the first windowed portion of the visual representation back to at least the forward mobile operator that generated the application command.

19. The method of claim 15, further comprising:
capturing and displaying a live feed of images from a mobile operator's current viewpoint on the handheld device display; and
transmitting the model manipulation command in accordance with the current viewpoint so that the visual representation of the 3D model streamed back to the mobile operator's handheld device is slaved to the operator's current viewpoint.

20. The method of claim 1, further comprising:
flying an unmanned aerial vehicle (UAV) above the scene at a given viewpoint to capture and transmit still or moving images to the host computer; and
slaving the viewpoint of the UAV to the current viewpoint of the 3D model in response to commands from the host operator or a mobile operator via the wireless network.

21. The method of claim 1, further comprising:
one or more said forward position mobile operators selecting a point on the displayed first windowed portion of the visual representation to generate a target point selection command;
transmitting the one or more target point selection commands over the wireless network to the host computer;
said host computer matching the one or more target point selection commands to the 3D model to extract a set of target coordinates; and
said host computer transmitting the target coordinates to deploy an asset to the target coordinates.

22. The method of claim 21, wherein the host computer highlights the target coordinates on the first windowed portion of visual representation that is streamed back to the requesting forward mobile operator with a confirmation prompt.

23. The method of claim 1, further comprising:
from either the forward positioned host computer or the mobile operator's handheld device, capturing a live feed of images of the scene in a global positioning satellite (GPS) signal-denied environment; and
correlating the live feed to the 3D model to estimate geo-coordinates of the host computer or mobile operator

24. The method of claim 23, further comprising displaying the live feed on the host computer display or handheld display and slaving the viewpoint of the visual representation of the 3D model to that of the live feed.

25. A method of providing enhanced situational awareness to a host operator and one or more forward positioned mobile operators, comprising:
providing a host computer with a three-dimensional (3D) model rendered from images of a scene capable of geometric manipulation from different viewpoints;
geo-rectifying the 3D model to geo-coordinates to geo-register the 3D model in scale, translation and rotation;
displaying a visual representation of the 3D model from a specified geo-accurate viewpoint on a host computer display, said host computer configured to allow host operator manipulation of the 3D model to change the viewpoint;
placing a first window on the host computer display, said host computer dynamically capturing a first windowed portion of the visual representation at a given refresh rate;
host computer streaming the first windowed portion of the visual representation over a wireless network to the handheld devices of one or more mobile operators forward positioned in the vicinity of the scene, said handheld devices configured to allow mobile operator to stream the first windowed portion of the visual representation to a handheld device display; and
mobile operator interaction via the wireless network with the 3D model to change the viewpoint of the rendered 3D model.

26. The method of claim 25, further comprising:
mobile operator interaction via the wireless network to select a point target on the 3D model; and
said host computer matching the selected point target to the 3D model to extract a set of target geo-coordinates.

27. The method of claim 25, further comprising:
capturing and displaying still or moving images from a mobile operator's current viewpoint on the handheld device display; and
changing the viewpoint of the rendered 3D model to slave the visual representation to the current viewpoint of the handheld device display.

28. The method of claim 25, further comprising:
flying an unmanned aerial vehicle (UAV) above the scene at a given viewpoint to capture and transmit still or moving images to the host computer; and
slaving the viewpoint of the UAV to commands from the mobile operator and current viewpoint of the 3D model.

29. A method of providing enhanced situational awareness to a host operator and one or more forward positioned mobile operators, comprising:
providing a host computer with three-dimensional (3D) model rendered from 2D images of a scene capable of geometric manipulation from different viewpoints;
geo-rectifying the 3D model to geo-coordinates to geo-register the 3D model in scale, translation and rotation;
displaying a visual representation of the 3D model from a specified geo-accurate viewpoint on a host computer display, said host computer configured to allow host operator manipulation of the 3D model to change the viewpoint;
placement of a first window on the host computer display, said host computer dynamically capturing a first windowed portion of the visual representation at a given refresh rate;
host computer streaming the first windowed portion of the visual representation over a wireless network to the handheld devices of one or more mobile operators forward positioned in the vicinity of the scene, said handheld devices configured to allow mobile operator selection to stream the first windowed portion of the visual representation to a handheld device display;
said one or more forward positioned mobile operators capturing live feeds of images of the scene and transmitting the live feeds and their geo-coordinates over the wireless network to the host computer;
displaying the one or more live feeds in one or more additional windows on the host computer display in conjunction with the visual representation of the 3D model; and
displaying a geo-positioned icon for each of the geo-located mobile operators within the visual representation of the 3D model.

30. The method of claim 29, further comprising:
slaving the viewpoint of the visual representation of the 3D model to the current viewpoint of one of the live feeds.

31. The method of claim 29, further comprising:
host operator selection of a single point on the visual representation of the 3D model to extract geo-coordinates from the 3D model; and
transmitting the geo-coordinates of said point as a set of target coordinates to deploy an asset to the target coordinates.

32. A system for providing enhanced situational awareness to a host operator and one or more forward positioned mobile operators, comprising:
a camera for recording images from diverse viewpoints about a scene;
a computer for rendering the images into a three-dimensional (3D) model capable of geometric manipulation from different viewpoints;
a wireless network;
a host computer for displaying a visual representation of the 3D model from a specified viewpoint on its display, said host computer configured to allow host operator manipulation of the 3D model to change the viewpoint and placement of a first window on the host computer display, said host computer dynamically capturing a first windowed portion of the visual representation of the 3D model at a given refresh rate and streaming the first windowed portion of the visual representation over the wireless network;
a plurality of handheld devices, each said device comprising a display configured to allow mobile operator selection of a first window to stream the first windowed portion of the visual representation, a camera to capture a live feed of images of the modeled scene for presentation on the handheld display and transmission via the wireless network to the host computer via the wireless network for display in conjunction with the visual representation of the 3D model, a global positioning system (GPS) receiver for determining geo-coordinates of the handheld device and transmitting the geo-coordinates via the wireless network to the host computer for displaying a geo-positioned icon of the mobile operator within the visual representation of the 3D model and an application configured to support mobile operator interaction with the 3D model via the wireless network to change the viewpoint.

33. The system of claim 32, wherein the host computer slaves the viewpoint of the 3D model to the current viewpoint of the live feed from one of the handheld devices.

34. The system of claim 32, wherein the host computer is configured to allow host operator selection of a point on the visual representation, said host computer matching the selected point to the 3D model to extract a set of target coordinates and transmitting the target coordinates to deploy an asset to the target coordinates.

35. The system of claim 34, wherein the handheld displays are configured to allow mobile operator selection of a point on the visual display, said handheld devices transmitting the selected point to the host computer to match the selected point to the 3D model to extract a set of target coordinates and transmit the target coordinates to deploy an asset to the target coordinates.

36. The system of claim 32, further comprising:
an unmanned aerial vehicle (UAV), said UAV flown above the scene at a given viewpoint to transmit a live feed of images to the host computer, said viewpoint of the UAV slaved to the current viewpoint of the 3D model in response to commands from the host operator or a mobile operator via the wireless network.
